(19) United States
(12) Patent Application Publication
(10) Pub. No.: US 2008/0319994 A1
(43) Pub. Date: Dec. 25, 2008

(54) METHOD FOR REGISTERING A TEMPLATE MESSAGE, GENERATING AN UPDATE MESSAGE, REGENERATING AND PROVIDING AN APPLICATION REQUEST, COMPUTER ARRANGEMENT, COMPUTER PROGRAM AND COMPUTER PROGRAM PRODUCT

(75) Inventors: Carl Binding, Rueschlikon (CH); Stefan Georg Hild, Somers, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/141,256

(22) Filed: Jun. 18, 2008

Related U.S. Application Data
(63) Continuation of application No. 11/262,681, filed on Oct. 31, 2005.

(51) Int. Cl. G06F 7/00; G06F 17/30

(52) U.S. Cl. 707/6; 707/102; 707/E17.044; 707/E17.014

(57) ABSTRACT

The invention relates to a method for registering a template message comprising identifying a request class containing a fixed and a variable content part, generating a template message comprising the fixed content part of the request class, and registering the template message for the request class with a template message database.

The invention further relates to a method for generating an update message, a method for regenerating an application request and a method for providing an application request. In addition, the invention relates to a computer arrangement, a computer program and a computer program product adapted to perform the methods according to the invention.

### CROSS REFERENCE TO RELATED APPLICATION

The present application is a continuation application of U.S. Ser. No. 11/262,681, filed Oct. 31, 2005, the entire contents of which are incorporated herein by reference.

### TECHNICAL FIELD

The present invention relates to a method for registering a template message, comprising identifying a request class containing a fixed and a variable content part, generating a template message comprising a fixed content part of the request class, and registering the template message for the request class with a template message data base. The invention further relates to a method for generating an update message, a method for regenerating an application request and a method for providing an application request. In addition, the invention relates to a computer arrangement, a computer program and a computer program product adapted to perform the methods according to the invention.

### BACKGROUND OF THE INVENTION

Due to the spread and the increased use of the internet an increasing amount of electronic requests is exchanged using open protocols, for example, using the hypertext transfer protocol, This also affects the area of distributed computing, where two or more computers are operationally connected in order to jointly perform a computational task. Compared to earlier solutions, where application-specific protocols were used for exchanging application requests between dedicated computers, more recent generic standard protocols such as the simple object access protocol (SOAP) allow cross-platform communication between loosely coupled systems. The SOAP protocol version 1.2 of the World Wide Web Consortium [retrieved from http://www.w3.org/TR/2003/REC-soap12-part1-20030624 at Oct., 12, 2005], is an application of and thus based on the Extensible Markup Language (XML) [retrieved from http://www.w3.org/TR/2004/REC-xml-20040204 at Oct. 12, 2005]. As such, all information transmitted must be encoded in a format that is both human and computer-readable. FIG. 3 shows an example of a SOAP request for obtaining bibliographic information from the Open Patent Service of the European Patent Office.

This representation has two main advantages over the use of application-specific protocols. Firstly, the request is much longer due to the verbosity of XML. For example, numeric values are expressed using a character-based representation rather than a shorter binary representation. In addition, field names are repeated for each request or even within a request rather than being fixed as application-specific protocols.

Secondly, due to the textual nature of the representation, received requests must be parsed into a data structure that can be processed further. The parsing process is computationally expensive and consequently often dominates the request latency in distributed applications.

Consequently, there exists a need for improved methods and devices for exchanging application requests in distributed applications.

### SUMMARY OF THE INVENTION

According to one aspect of the invention, a method for registering a template message is provided. The method comprises the steps of identifying a request class containing a fixed and a variable content part, generating a template message comprising the fixed content part of the request class, and registering the template message for a request class with a template message database.

By generating and registering a common template for a class of application requests, parts that remain unchanged throughout this request class can be readily identified.

According to a preferred embodiment of the first aspect, the request class is identified based on schema information, which contains metadata about the fixed and variable content part.

Many distributed applications provide metadata about the messages they are exchanging. The metadata contains a formal description of the input and output data a specific application expects. Using this metadata allows to automatically analyze which part of the content of an application request is fixed or variable.

According to another preferred embodiment of the first aspect, the request class is identified based on differential analysis of a group of example application requests from the request class.

In case of applications, for which no metadata or schema information is available, a differential analysis of example application requests can be used to determine the request class in general and the fixed and variable content part in particular. By comparing two or more messages it may be determined what parts of an application request change from one message to another.

According to a further preferred embodiment of the first aspect, the template message is generated by a server and transmitted to a client sending an initial message.

As the server knows the application services it is providing, and, consequently, the application requests it can serve, it can provide template messages for these application requests and provide them to clients exchanging data with it.

According to another embodiment of the first aspect, the template message is generated by a client and transmitted to a server by sending an initial message.

In cases where a client communicates with different servers, for example, it may be more efficient for the client to compute the template message and send it to the server for further communication.

According to another embodiment of the first aspect, the initial message further comprises a standard value for at least a part of the variable content part identified for the request class.

In cases in which a standard value for a certain variable content part is often exchanged between a client and a server, such a standard value can be transmitted with the initial message in order to allow further optimization.

According to a second aspect of the present invention, a method for generating an update message is provided. The method comprises the steps of providing an application request comprising a fixed and a variable content part, selecting a template message from a predetermined set of template messages, each comprising a fixed content part, the selected template message being compatible to the application request, and generating an update message, containing the variable content parts of the application request.

By comparing an application request with a set of previously generated template messages with fixed content parts and selecting one that is compatible to it, an update message can be constructed, which only contains the variable content part of application request. Consequently, the update message is shorter than the initial application request. This is particularly advantageous for transmitting the update message over a slow data connection, such as a mobile phone network.

According to a preferred embodiment of the second aspect, the selected template message is selected based on an identifier contained in the application request and the template message.

If a fixed identifier, such as the application name or unique registration number of a template, is available for the template message and provided by the application, the template message can be selected easily by means of the identifier.

According to another embodiment of the second aspect, the selected template message is selected based on a comparison of the fixed content part of the application request with the fixed content part of the template message.

Another means of selecting a compatible template message for a given application request is to compare the fixed content part of an application request with the fixed content parts of template messages available. Thus, no unique application identifiers are required for the selection process. This also allows to use different template messages for one and the same application, depending, for example, on the specific application request.

According to a third aspect of the present invention, a method for regenerating an application request is provided. The method comprises the steps of receiving an update message comprising a variable content part, selecting a template message from a predetermined set of template messages, each comprising a fixed content part, the selected template message being compatible to the update message, and applying the variable content part contained in the update message to the selected template message comprising the fixed content part, such that an application request comprising the fixed and variable content part is regenerated.

By combining the variable content part received with an update message with the fixed content part contained in a selected, compatible template message, the original application request can be regenerated. This process can, for example, take place at a server computer, which has local access to the required template message.

According to a preferred embodiment of the third aspect, the selected template message is selected based on an identifier contained in the update message and the template message.

By providing an identifier, a received update message can easily be matched to a compatible template message.

According to another embodiment of the third aspect, the selected template message further comprises at least one standard value to be included in the regenerated application request, if no corresponding data values in the variable content part is contained in the update message.

Consequently, frequently occurring standard values of the variable content part of an application request can be set to a default and do not need to be provided repeatedly as part of an update message, further improving efficiency.

According to a preferred embodiment of the third aspect, the selected template message is pre-processed by parsing the selected template message into an in-memory data structure with at least one data field, and applying the variable content parts comprises updating the in-memory data structure by replacing or adding at least one data field with data values comprised in the variable content parts of the update message.

In cases where the fixed content part of the application requests determines a particular data structure for information required, a suitable data structure can be generated based on the template message. This pre-processed data structure only needs to be updated with specific data values comprised in the variable content parts of an update message. Consequently parsing of an application request only needs to be performed once, upon first provision of a template message.

According to a further improved embodiment of the third aspect, the in-memory data structure is a document object model, and applying the variable content parts comprises updating an instance of the document object model.

For some message formats, such as XML, there exists standard in-memory representation called document object models, which can be used to represent the data contained in a received message independent of a specific application. By updating an instance of such a document object model, the information comprised in an application request can be provided to an application in a standard conformant way.

According to a fourth aspect of the present invention, a method for providing an application request is provided. The method comprises the steps of registering a template message according to the first aspect of the invention, providing the template message to a client and a sever using an initial message, generating an update message for an application request provided to the client according to the second aspect, transmitting the update message from the client to the server, regenerating the application request by the server according to the third aspect, and providing the application request to an application service provider.

By combining methods according to the first, second and third aspect of the invention, the process of transmitting an application request from a client to a server can be split into two phases. In a first phase, a template message suitable for the application request is registered and provided to both the client and the server. This process only needs to take place once. Then, in the second process, update messages are generated and transmitted from the client to the server for every application request received by the client. Using the previously provided template message in combination with the transmitted update message the server can regenerate the complete application request and send it to an application service provider. In effect, the data transmitted between a client and a server can be reduced if several application requests are transmitted from a client to a server, because for all subsequent messages only the second process needs to be performed.

According to a preferred embodiment of the fourth aspect, the application request, the template message, the update message or the initial message are encoded using a markup language comprising markup elements, which are used to encode the fixed content part, and marked-up data, which is used to encode the variable content part.

By using a markup language, it is easy to generate self-describing application requests and messages, which allow to distinguish between the fixed content part formed by the markup and the variable content part formed by the data being marked up.

According to an improved embodiment of the fourth aspect, the markup language is the extensible markup language, the markup elements comprise XML elements and attribute names and the marked up data comprises character data and attribute values.

By using the extensible markup language, an open standard format for data representation, to application request can be transmitted across platform boundaries.

According to a fifth aspect, a computer arrangement comprising an operationally connected client and a server, is provided. An application of the client is adapted to transmit an application request comprising a fixed and a variable content part. A template encoder of the client is adapted to receive the application request and compare it with a predetermined template message and to encode and transmit an update message comprising the variable content part of the application request. A template decoder of the server is adapted to receive and decode the update message, applying the variable content part contained in it to the predetermined template message, such that the original application request is regenerated. The regenerated application request is then transmitted to an application service provider of the service, which is adapted to receive it for further processing.

By splitting the client system into an application and a template encoder, the application can be provided independently from the application request transmitting mechanism. Consequently, for example, an existing SOAP application can be executed on a client computer with such an application request being encoded in accordance with an embodiment of the present invention. Inversely, at the server's side, the separation of a template decoder and an application service provider means that the application service provider can be left unchanged, while a special template decoder is used to decode update messages generated in accordance with an embodiment of the second aspect of the present invention.

According to a preferred embodiment of the fifth aspect, a template message database, operationally connected to the client and the server is further comprised in the computer arrangement.

By providing a template message database, which can be, for example, centrally managed, template messages become available both to the client and the server.

According to a sixth aspect of the present invention, a computer program is provided comprising program instructions adapted to perform all the steps performed by the first, second or third aspect of the invention.

According to a seventh aspect of the invention, a computer program product is provided. The computer program product comprises a computer readable medium embodying program instructions executable by a computer to receive an application request comprising fixed and variable content parts, select a template message from a predetermined set of template messages, each comprising a fixed content part, the selected template message being compatible to the application request, and generate an update message containing the variable content part of the application request. By performing these steps, a compact update message can be generated by the computer in response to receiving an application request.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1, a schematic dataflow diagram of a first application request in accordance with an embodiment of the present invention,

FIG. 2, a schematic dataflow diagram of a subsequent application request in accordance with an embodiment of the present invention.

FIG. 3, an example of an application request in the SOAP protocol,

FIG. 4A, an example of a first template message,

FIG. 4B, an example of a first update message,

FIG. 5A, an example of a second template message containing standard values,

FIG. 5B, an example of a second update message containing data values,

### DETAILED DESCRIPTION OF THE DRAWINGS

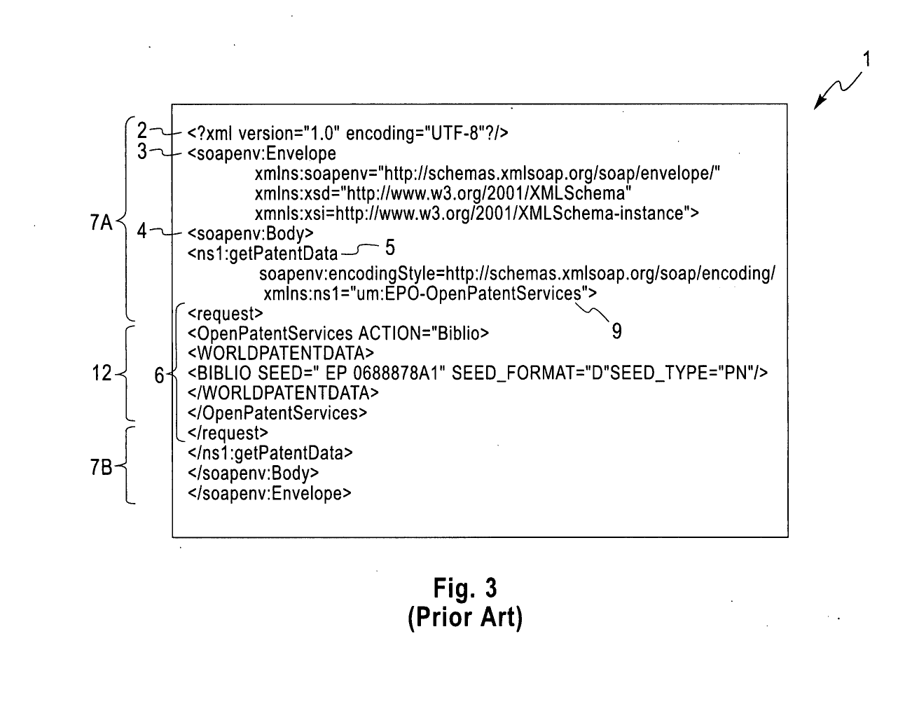

FIG. 3 shows an example application request 1 encoded in a message in accordance with the SOAP standard. Details about the SOAP standard can be found, for example, in chapter 12 of the book “Java & XML”, 2nd Edition, O'Reilly, 2001 by Brett McLaughlin. Messages in accordance with the SOAP standard comprise at least a so-called XML preamble 2, which is fixed by the XML standard and thus is the same for all application request 1, a SOAP envelope 3 and a SOAP body 4.

The SOAP envelope 3 contains data about the actual data payload, i.e. the SOAP body 4. For example, the SOAP envelope 3 can contain information about the message encoding, the recipient or the sender. The information of the SOAP envelope 3 is processed prior to the data contained in the SOAP body 4. It can be used, for example, for routing of a service call 5 to a specified service provider or for pre-processing of application data 6. Due to the hierarchical nature of XML, the SOAP envelope 3 encloses the SOAP body 4.

The SOAP body 4 contains the data of the application request 1 to be transmitted from a sender to a recipient in general and from an application to an application service provider in the context of this description. In the given example, the SOAP body 4 contains the service call 5 to an application service to be used, named “getPatentData” in the given example, and the application data 6 to be passed on to that service as input parameters. The application data 6 comprises, among others, an XML element with the name “OpenPatentService” and an attribute called “ACTION” set to the value “Biblio”, which indicates that bibliographic information are to be retrieved. It further comprises an XML element “BIBLIO” with an attribute “SEED” serving as a seed to start the bibliographic search given by a publication number.

Most of the elements of the application request 1 shown in FIG. 3 are fixed for the particular service call 5. Particularly, the XML preamble 2, the SOAP envelope 3 and the beginning and end of the SOAP body 4 are fixed. Together they form a fixed part 7 comprising two subparts 7A and 7B, preceding and succeeding a variable part 12 of the application request 1, respectively.

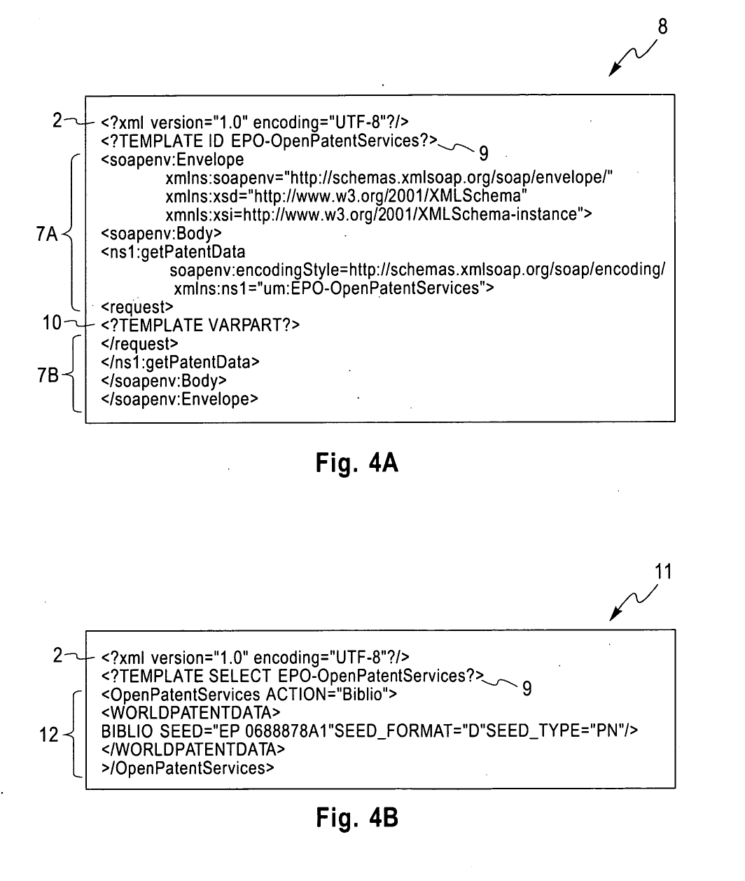

FIG. 4A shows a template message 8 comprising the fixed subparts 7A and 7B of the application request 1. In addition to the fixed part 7, the template message 8 comprises an identifier 9 and a placeholder 10. The identifier 9 allows to associate the template message 8 with a particular application request class. In the given example, the identifier 9 was taken from a so called namespace definition contained in the service call 5 of the SOAP body 4, which associates the service call 5 of the application request 1 with a uniform resource name (urn), namely “EPO-OpenPatentService”. The placeholder 10 marks the position of the previously removed variable part 12 in the template message 8. Both, the identifier 9 and the placeholder 10 were inserted in the form of XML processing instructions. Though this is not essential for the invention, it allows to process the template message 8 using the same framework that can be used to process the original application request 1.

FIG. 4B shows an update message 11, which contains the variable part 12 of the application request 1. The update message 11 further comprises the XML preamble 2 and the identifier 9, which is used to associate the update message 11 with the compatible template message 8. In the example given, the variable part 12 is a subset of the application data 6 of the application request 1 shown in FIG. 3. By substituting the placeholder 10 of the template message 8 with the variable content part 12 of the update message 11, the original application request 1 can be regenerated.

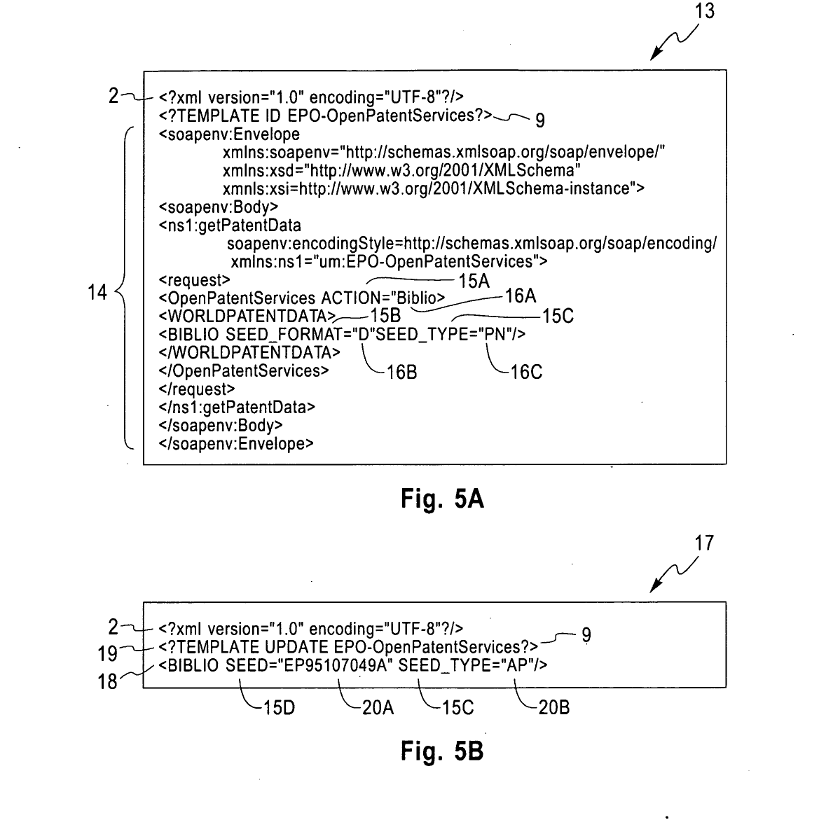

FIG. 5A shows another possible template message 13 for the application request 1, in which to further parts of the application data 6 are contained in a fixed part 14. In particular, the complete structure of the application data 6, i.e. all elements and sub-elements of the SOAP body 4, is contained in the fixed part 14. The literal attributes “ACTION” 15A, “SEED_FORMAT” 15B and “SEED_TYPE” 15C are set to standard values 16A, 16B and 16C respectively. The template message 13 does not, however, contain an attribute “SEED” like the application request 1, as there exists no reasonable standard value for such an attribute.

FIG. 5B shows a corresponding update message 17 with a variable part 18 comprising data values 20A and 20B for attributes 15D and 15C. A processing instruction 19 instructs a processing device to update the template message 13 with the variable part 18 of the update message 17 in order to regenerate the original application request 1.

It should be noted that the update message 17 comprises a first data value 20B for the attribute 15C already present in the associated template message 13, but also comprises a second data value 20A for an attribute 15D not present in the template message 13. On combining the template message 13 with the update message 17 as described below, standard values 16 will be used for those attributes 15, for which no data value 20 is provided in the update message 17. In the given example, the standard values 16A and 16B will be used for the attributes 15A and 15B respectively, while the data value 20B will be used for the attribute 15C, but not the standard value 16C. In addition, the attribute 15C together with the data value 20A of the update message 17 will be inserted into the template message 13 in order to complete the complete application request 1.

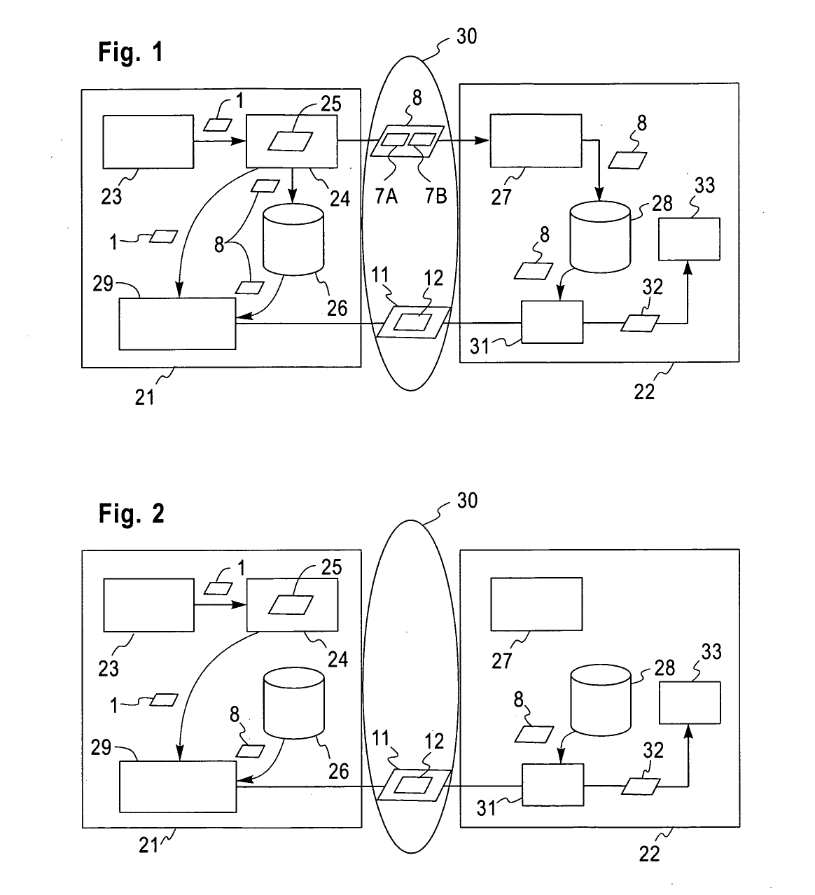

FIG. 1 shows a schematic dataflow diagram for a first application request 1 to be transmitted from a client 21 to a server 22. An application 23 running on the client 21 transmits the application request 1 to a template generator 24. The template generator 24 analyzes the application request 1 in order to determine the application request class 25. On identifying a new application request class 25 the template generator 24 generates a suitable template message 8 containing the fixed content parts 7A and 7B of the application request 1 and puts it into a first to template database 26. The template generator 24 further transmits the template message 8 to a template acceptor 27 of the server 22 using a data network 30. Upon receiving a new template message 8, the template acceptor 27 puts the new template message 8 into a second template database 28 at the server side.

Once a suitable template message 8 for the application request 1 exists, the application request 1 is encoded by the template encoder 29 of the client 21. For example, the template generator may forward the application request 1 and the template message 8 to the template encoder 29. Alternatively, the application 23 can send its request 1 directly to the template encoder 29, which then retrieves the template message 8 directly from the first template database 26. The template encoder 29 separates the fixed parts 7A and 713 of the application request 1 from the variable part 12. The variable part 12 is then encoded in an update message 11, which is sent to the server 22 over the data network 30. In addition to the variable part 12, the update message 11 may contain an identifier 9 associated with the template message 8 used by the template encoder 29.

Upon reception of the update message 11a template decoder 31 retrieves the compatible template message 8 from the second template database 28 and combines its fixed part 7 with the variable part 12 contained in the update message 11. Consequently, a regenerated application request 32 contains the same information as the original application request 1. The regenerated application request 32 is then processed by an application service provider 33 running on the server 22.

The required operations can be implemented either in hardware alone or as a combination of hardware and software. A computer readable medium may be provided embodying program instructions executable by one or a combination of the client 21 and server 22 of the computer arrangement shown in FIG. 1. The computer readable medium may for example be a CD-ROM, a flash memory card, a hard disc or any other suitable computer readable medium.

FIG. 2 shows a schematic dataflow diagram of a subsequent application request 1 sent from the application 23 of the client 21 to the application service provider 33 of the server 22. Upon receiving an application request 1, the template generator 24 finds a suitable template message 8 already contained in the first template database 26. As no new template message 8 needs to be generated or registered with the server 22, the template generator 24 passes the application request 1 on to the template encoder 29. The template encoder 29 retrieves the already existing template message 8 from the first template database 26. As described above, the template is encoder 29 separates the variable part 12 from the rest of the application request 1 and encodes it in an update message 11. The update message 11 is then transmitted to the template decoder 31 of the server 22. The template decoder 31 retrieves the already available template message 8 from the second template database 28 and uses it to regenerate an application request 32 equal to the original request 1 at the server side 22. The regenerated application request 32 is then provided to the application service provider 33 for further processing.

If many similar application requests 1 belonging to a common application request class 25 are transmitted from the client 21 to the servers 22, the method described above and in accordance with an embodiment of the present invention significantly reduces the amount of data being exchanged between the client 21 and the server 22. Because for all but the first application request 1 only an update message 11 containing the variable part 12 of the application request 1 needs to be transmitted from the client 21 to the server 22, a repeated transmission of the fixed part 7 of the application request 1 can be avoided.

In addition, if the data structure represented by a template message 8 is stored in a pre-parsed format in the second database 28 or is cached by the template decoder 31, the template decoder 31 does not need to parse a typically lengthy XML application request 1 upon each request received. Instead, only the comparatively short update messages 11 needs to be parsed in order to recover the variable content part 12, which can then be used to update the data structure already comprised in the template decoder 31.

For example, a document object model as defined by the W3C DOM standard can be generated upon reception or first registration of a template message 8 and then be updated with the variable content part 12 received in subsequent update messages 11.

The effort required for parsing can be further reduced for application requests 1 comprising relatively complex application data 6. If the structure of this data is also fixed for all application requests 1 and encoded in a template message 13, it too can be pre-processed at the time of first providing the template message 13. For subsequent update messages 17, only individual elements 15 of such a pre-processed data structure need to be updates with data values 20 contained in the update message 17.

As becomes obvious by comparing the template messages 8 and 13 of FIGS. 4A and 5A, respectively, the fixed part 7 and 14 can consist of an arbitrary number of subparts 7A, 7B, attributes 15A, 15B and 15C, or the like. Equally, the variable part 12 and 18 can be composed of individual data values 20A and 20B or be represented as a single item 12.

Although in FIG. 1 it is shown that the template message 8 is generated by the client 21 upon first receiving the application request 1 of an application request class 25, the template generator 24 could also be part of the server computer 22. For example, an application service provider 33 could make available template messages 8 for all application requests 1 that it can handle. The associated template messages 8 could then be stored in the second template database 28 and be made available to the first template database 26 of the client 21 over the data network 30.

It is also possible to provide a template database 26 which is not part of either the client 21 or the server 22. For example, a dedicated, separate template database 26 could be included in the data network 30. Consequently, the template generator 24, the template encoder 29 and the template decoder 31 could query the template database 26 in order to obtain a valid template message 8 for a given application request 1.

In a preferred embodiment, the template encoder 29 or the template decoder 31 are implemented in a application proxy. Consequently, the application 23 or the application service provider 33 can remain unchanged, while transmission efficiency for the data network 30 is improved.

Although FIG. 1 and FIG. 2 show a data network 30 with a single client 21 and a single server 22, the data network 30 will contain several clients 21 or servers 22 in general. In addition, the functional units 23, 24, 26, 27, 28, 29, 31 and 33 could be distributed over an arbitrary number of computer systems in a common data network 30. In particular, all functional units could be comprised in a single computer system or be comprised in one computer system each.

In addition the role of the client 21 and the server 22 can be swapped around, for example for providing an answer to an application request 1 allowing a true two-way communication with reduced data traffic on the data network 30. In such a system, optimized template messages 8 or 13 or default values 16 can be used throughout a session comprising several related application request 1.

Many other modifications of the message format used, the architecture of the computer arrangement and the sequence of the steps of the methods will be obvious to a person skilled in the art and can be used without departing from the spirit of the present invention.

1. Method for registering a template message comprising
identifying a request class containing a fixed and a variable content part,
generating a template message comprising the fixed content part of the request class, and
registering the template message for the request class with a template message database.

2. Method according to claim 1, wherein
the request class is identified based on schema information, which contains metadata about the fixed and the variable content part.

3. Method according to claim 1, wherein
the request class is identified based on differential analysis of a group of example application requests from the request class.

4. Method according to claim 1, wherein
the template message is generated by a server and transmitted to a client by sending an initial message.

5. Method according to claim 1, wherein
the template message is generated by a client and transmitted to a server by sending an initial message.

6. Method according to claim 4, wherein
the initial message further comprises at least one standard value for at least a part of the variable content part identified for the request class.

7. Method for generating an update message, comprising
providing an application request comprising a fixed and a variable content part,
selecting a template message from a predetermined set of template messages, each comprising a fixed content part, the selected template message being compatible to the application request, and
generating an update message, containing the variable content part of the application request.

8. Method according to claim 7, wherein
the selected template message is selected based on an identifier contained in the application request and the template message.

9. Method according to claim 7, wherein
the selected template message is selected based on a comparison of the fixed content part of the application request with the fixed content parts comprised in the set of template messages.

10. Method for regenerating an application request, comprising
receiving an update message comprising a variable content part,
selecting a template message from a predetermined set of template messages, each comprising a fixed content part, the selected template message being compatible to the update message, and
applying the variable content part contained in the update message to the selected template message comprising the fixed content part such that an application request comprising the fixed and variable content part is regenerated.

11. Method according to claim 10, wherein
the selected template message is selected based on an identifier comprised in the update message and the selected template message.

12. Method according to claim 10, wherein
the template message further comprises at least one standard value to be included in the regenerated application request, if no corresponding data value is comprised in the variable content part of the update message.

13. Method according claim 10, wherein
the selected template message is pre-processed by parsing the selected template message into an in-memory data structure with at least one data field, and
applying the variable content part comprises updating the in-memory data structure by replacing or adding at least one data field with a data value comprised in the variable content part of the update message.

14. Method according to claim 13, wherein
the in-memory data structure is a document object model (DOM), and
applying the variable content parts comprises updating an instance of the document object model.

15. Method for providing an application request, comprising
registering a template message according to claim 1,
providing the template message to a client and a server using an initial message,
generating an update message for an application request provided to the client,
transmitting the update message from the client to the server,
regenerating an application request by the server, and
providing the regenerated application request to an application service provider.

16. Method according to claim 15, wherein
the application request, the template message, the update message or the initial message are encoded using a markup language comprising markup elements, which are used to encode the fixed content part and marked up data, which is used to encode the variable content part.

17. Method according to claim 16, wherein the markup language is the extensible markup language (XML), the markup elements comprise XML elements and attribute names and the marked up data comprises character data and attribute values.

18. Computer arrangement comprising a client and a server, operationally connected, wherein
an application of the client is adapted to provide an application request, the application request comprising a fixed and a variable content part,
a template encoder of the client is adapted to receive the application request and compare it with a predetermined template message comprising a compatible fixed content part and to encode and transmit an update message, comprising the variable content part of the application request,
a template decoder of the server is adapted to receive and decoder the update message, applying the variable content part contained in it to the predetermined template message, such that an application request equal to the application request is regenerated at the server, and to transmit the regenerated application request, and
an application service provider of the server is adapted to receive the regenerated application request.

19. Computer arrangement according to claim 18, further comprising
at least one template message database operationally connected to the client or the server.

20. A computer program comprising program instructions adapted to perform all the steps performed by claim 1, when the computer program is run on a computer.

21. Computer program product comprising computer-readable mediun embodying program instructions executable by a computer to
receive an application request comprising fixed and variable content parts,
select a template message from a predetermined set of template messages, each comprising a fixed content part, the selected template message being compatible to the application request, and
generate an update message, containing the variable content part of the application request.
